(19) United States
(12) Patent Application Publication
(10) Pub. No.: US 2026/0367683 A1
(43) Pub. Date: Nov. 19, 2026

(54) DISTRIBUTION PREDICTION FOR HARDWARE POWER MANAGEMENT

(71) Applicant: QUALCOMM Incorporated, San Diego, CA (US)

(72) Inventors: Mustafa KESKIN, San Diego, CA (US); Jian SHEN, San Diego, CA (US)

(21) Appl. No.: 19/209,302

(22) Filed: May 15, 2025

(51) Int. Cl. G06F 1/26

(52) U.S. Cl. CPC G06F 1/26

(57) ABSTRACT

Certain aspects of the present disclosure provide techniques and apparatus for supplying power. In an example method, an input for a first machine learning model comprising a plurality of operations is accessed, and a set of input statistics is determined based on the input. A power dissipation of one or more hardware components configured to implement the first machine learning model is predicted, the predicting being based on processing the set of input statistics using a second machine learning model. Power provided to the one or more hardware components is controlled, based on the predicted power dissipation, while the input is processed using the plurality of operations of the first machine learning model.

Aspects of the present disclosure relate to supplying power in computing systems.

A wide variety of machine learning model architectures have been trained to perform an assortment of diverse tasks, including computer vision tasks, language tasks, classification and regression tasks, and the like. Recently, research has yielded substantial success in large machine learning models, such as language models (e.g., large language models (LLMs)), large vison models (LVMs), and/or large multimodal models (LMMs). Many models, and particularly large models (e.g., models with millions or even billions of parameters), are compute intensive. Further, processing data using such models results in substantial power dissipation and heat generation.

### BRIEF SUMMARY

Certain aspects of the present disclosure provide a processor-implemented method of supplying power, comprising: accessing an input for a first machine learning model comprising a plurality of operations; determining a set of input statistics based on the input; predicting a power dissipation of one or more hardware components configured to implement the first machine learning model, the predicting being based on processing the set of input statistics using a second machine learning model; and controlling power provided to the one or more hardware components, based on the predicted power dissipation, while the input is processed using the plurality of operations of the first machine learning model.

Certain aspects of the present disclosure provide a processor-implemented method of controlling operation implementation, comprising: accessing an input for a sequence of operations; determining a set of input statistics based on the input; predicting one or more statistics of the sequence of operations when executed using one or more hardware components, the predicting being based on processing the set of input statistics using a machine learning model; and controlling at least one of (i) workload scheduling, (ii) power provided to the one or more hardware components, or (iii) frequency of the one or more hardware components, based on the one or more predicted statistics, while the input is processed using the sequence of operations.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 depicts an example workflow for training machine learning models to improve power management, according to some aspects of the present disclosure.

FIG. 2 depicts an example workflow for using machine learning models to improve power management, according to some aspects of the present disclosure.

FIG. 3 is a flow diagram depicting an example method for controlling power for machine learning model usage, according to some aspects of the present disclosure.

FIG. 4 is a flow diagram depicting an example method for controlling compute operations based on predicted statistics, according to some aspects of the present disclosure.

FIG. 5 is a flow diagram depicting an example method for supplying power, according to some aspects of the present disclosure.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved power supply. Specifically, in some aspects of the present disclosure, techniques are provided for more efficient and effective power management in computing devices.

While a large variety of machine learning architectures can be used to perform machine learning, each relies on physical hardware components (e.g., one or more processors and/or accelerators) to implement or perform the actual operations. To perform these operations, the hardware components consume electrical power. As used herein, this consumption may be referred to as “power dissipation” of the components (e.g., the electrical power that is used and/or converted to heat or other forms of power by the hardware circuits while processing data).

Many machine learning model architectures involve sequential processing of the data, where the actual data being processed by each operation and/or the actual operation being performed can vary widely. For example, in neural networks, the input tensor to each layer may differ from each other layer, and the operations performed within each layer may similarly vary. Because of these differences in put and/or operations, the power dissipation of each operation can exhibit extreme variations. This variability can cause substantial difficulty to power management efforts (e.g., to prepare for and respond to the power demands).

For example, the input to the model (e.g., an input image and/or video) may have vastly different distributions across each channel (e.g., the red, green, and blue channels for red/green/blue (RGB) images). Further, the variations in the data produced by the internal operations of the model (e.g., the internal layers) based on this input can similarly exhibit substantial variation. These variations result in significantly complicated switching regulators, both in terms of cost and also in terms of power dissipation (e.g., battery life, for battery operated devices).

In some aspects, to improve power supply management, distribution statistics from one portion of the machine learning model workflow (e.g., the distribution of the input data, the distribution of data generated by one or more internal layers, the distribution of the parameters of the model itself, and the like) can be processed using a separate machine learning model trained to predict future distributions that the model will exhibit (e.g., during subsequent operations in the sequence) and/or to predict future power dissipation of the one or more subsequent operations.

These predictions can then be used to control or manage the power supply to the hardware components implementing the model. For example, the system may predict the power dissipation for a given layer of the model based on the distributions of the input image, and control the power supply to the hardware components (e.g., the accelerator) when the given layer is processed based on the previously generated predictions.

Although some examples of the present disclosure describe processing tensor distributions to predict future power dissipation in hardware components implementing a machine learning model, aspects of the present disclosure are readily applicable to a wide variety of computing environments. For example, in some aspects, a variety of operation distributions may be evaluated to predict a variety of future operation distribution statistics in order to perform workload scheduling, dynamic voltage and frequency scaling (DVFS), and the like.

### Example Workflow for Training Machine Learning Models to Improve Power Management

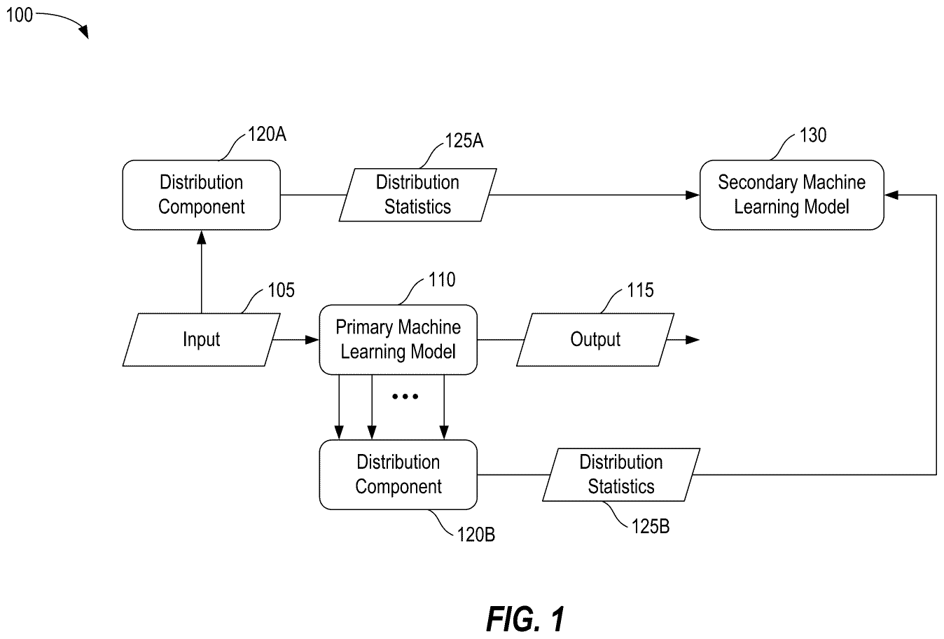

FIG. 1 depicts an example workflow 100 for training machine learning models to improve power management, according to some aspects of the present disclosure. The workflow 100 is generally performed by a machine learning system (e.g., a computing system configured to train and/or use machine learning models to process data). The machine learning system may generally correspond to any suitable computing system, such as a server, desktop computer, laptop computer, smartphone, wearable device, and the like. The machine learning system may be powered via battery (e.g., mobile devices) and/or via mains power.

In the illustrated workflow 100, an input 105 is processed by a primary machine learning model 110 to generate a corresponding output 115. Generally, the particular contents and format of the input 105 and the output 115 may vary depending on the particular implementation. For example, in some aspects, the input 105 may correspond to or include image data (e.g., an RGB image), and the output 115 may describe or correspond to the image (e.g., a depth map, a semantic segmentation, a classification, and the like). Generally, the architecture of the primary machine learning model 110 may similarly vary depending on the particular implementation. For example, the primary machine learning model 110 may comprise or correspond to a neural network, a language model (e.g., an LLM), a transformer-based model, and the like.

In some aspects, the primary machine learning model 110 comprises or implements a sequence of discrete operations (also referred to in some aspects as model components) to process the input 105. For example, depending on the particular architecture, the primary machine learning model 110 may comprise a sequence of layers, kernels, transformers, and the like.

In some aspects, the workflow 100 may be performed to train a secondary machine learning model 130 (also referred to in some aspects as an “auxiliary” model and/or a “statistics prediction” model) to predict operation statistics for one or more operations of the primary machine learning model 110. The particular architecture of the secondary machine learning model 130 may vary depending on the particular implementation. For example, the secondary machine learning model 130 may comprise or implement a neural network. In some aspects, the size of the secondary machine learning model 130 may be substantially smaller than the size of the primary machine learning model 110. For example, the secondary machine learning model 130 may comprise a relatively small number of layers (e.g., three to five layers) each having a relatively small number of neurons (e.g., ND, where N is the number of operations (e.g., layers) in the primary machine learning model 110 for which a prediction is generated, and D is the number of distribution statistics that are predicted for each operation.

In some aspects, the workflow 100 is performed during training, refinement, and/or fine-tuning of the primary machine learning model 110. In some aspects, the workflow 100 is performed after the primary machine learning model 110 is trained and the parameters are frozen.

In the illustrated workflow 100, the input 105 is also accessed by a distribution component 120A. As used herein, “accessing” data may generally include receiving, requesting, retrieving, obtaining, generating, collecting, capturing, or otherwise gaining access to the data. For example, the input 105 may be captured using one or more imaging sensors (e.g., a camera) of the machine learning system. Although depicted as a discrete component for conceptual clarity, in some aspects, the operations of the distribution component 120A may be performed by one or more other components of the machine learning system.

As illustrated, the distribution component 120A generates a set of distribution statistics 125A based on the input 105. The distribution statistics 125A generally reflect one or more statistics (e.g., the mean, mode, standard deviation, variance, and the like) of one or more distributions (e.g., a distribution of pixel values) of the input 105. In some aspects, if the input 105 has multiple channels (e.g., a first channel for red image data, a second channel for green image data, and a third channel for blue image data), the distribution component 120A may determine a respective distribution for each respective channel (e.g., where the distribution of a given channel refers to the distribution of element values, such as pixels, in the channel).

For example, if the input 105 comprises three channels, the distribution statistics 125A may include, for each respective channel, a respective mean and a respective variance. Generally, the distribution statistics 125A may include any statistic describing the distribution, such as the 1^{st} and/or 3^{rd} percentiles (or other quantiles), the minimum value, the maximum value, the skewness, the kurtosis, the median, the mode, the range, and the like. In some aspects of the present disclosure, the input statistic distribution statistics 125A may be designated as S₀ (e.g., comprising the mean μ₀ and the standard deviation σ₀ of each channel).

In the illustrated workflow 100, the distribution statistics 125A of the input 105 are used as input to the secondary machine learning model 130. Although not pictured in the illustrated example, in some aspects, the secondary machine learning model 130 may also receive, as input, distribution statistics for one or more operations or components of the primary machine learning model 110 itself. For example in some aspects, the input may include statistics (e.g., mean, standard deviation, skewness, kurtosis, and the like) of the distribution of parameters (e.g., weights and/or biases) of one or more operations (e.g., layers) of the primary machine learning model 110. For example, the mean and standard deviation of the parameters (e.g., weights) of the first layer may be designated μw₁ and σw₁, respectively.

In some aspects, the secondary machine learning model 130 may process distribution statistics for multiple operations in the primary machine learning model 110. For example, in some aspects, the distribution statistics for each operation may be concatenated sequentially (according to the sequence of the operations themselves) and/or normalized, and this concatenated and/or normalized set of statistics may be used as input to the secondary machine learning model 130. In some aspects, rather than evaluating distribution statistics for every operation of the primary machine learning model 110, distribution statistics for a subset of the layers may be used (e.g., every other layer, every fifth layer, every tenth layer, and the like). In some aspects, using the distribution statistics of the model parameters may be particularly useful for larger primary machine learning models 110 (e.g., deep models with a large number of operations).

In the illustrated example, the secondary machine learning model 130 may process this input to generate an output prediction. In some aspects, the output of the secondary machine learning model 130 comprises predicted distribution statistics for one or more of the operations of the machine learning model. For example, if the n-th layer of the primary machine learning model 110 receives an intermediate tensor (also referred to in some aspects as an “activation tensor,” “activation data,” or “intermediate data”) generated based on the input 105 (e.g., by the prior layer), the secondary machine learning model 130 may predict the distribution statistics of this intermediate tensor (e.g., predicting the mean μₙ and standard deviation σₙ of each channel in the intermediate tensor).

In some aspects, the secondary machine learning model 130 generates predicted statistics for each operation of the primary machine learning model 110. In some aspects, the secondary machine learning model 130 generates predicted statistics for a subset of the operations of the primary machine learning model 110 (e.g., every other layer, every tenth layer, and the like).

In the illustrated workflow 100, to train the secondary machine learning model 130, a distribution component 120B (which may correspond to the distribution component 120A, and may be implemented using hardware, software, or a combination of hardware and software) generates distribution statistics 125B for one or more of the operations of the primary machine learning model 110. For example, as the input 105 is processed using the primary machine learning model 110, the activation tensors generated as output of each given layer may be evaluated to generate a corresponding predicted set of distribution statistics for the next layer (e.g., to which the activation tensor will be used as input), as discussed above. In some aspects, to facilitate training of the secondary machine learning model 130, these distribution statistics 125B may be concatenated sequentially (e.g., in a concatenation layer of the secondary machine learning model 130) and/or normalized (e.g., in a normalization layer of the secondary machine learning model 130), as discussed above.

As illustrated, these model distribution statistics 125B may be used as the label or target output during training of the secondary machine learning model 130. For example, the predicted distribution statistics generated by the secondary machine learning model 130 may be compared against the actual distribution statistics 125B to generate a loss (e.g., cross-entropy loss), and this loss may be used to refine the parameters of the secondary machine learning model 130 (e.g., using backpropagation).

Generally, this training process may be performed for one or more iterations using one or more samples of input 105 (e.g., using batch gradient descent and/or stochastic gradient descent). Once the secondary machine learning model 130 is trained (e.g., after a defined number of iterations, after the differences between the predicted distribution statistics and the actual distribution statistics 125B is below a threshold, and the like), the secondary machine learning model 130 may be deployed for inferencing alongside the primary machine learning model 110. Generally, deploying the model may include any operations used to prepare or provide the model for inferencing, such as transmitting the parameters of the secondary machine learning model 130 to another system for inferencing, instantiating the model for local inferencing (e.g., moving the parameters to a memory that will be used to execute the model), and the like.

Although the illustrated example depicts training the secondary machine learning model 130 to generate distribution statistics corresponding to the operations of the primary machine learning model 110, in some aspects, the secondary machine learning model may additionally or alternatively be trained to directly predict the power dissipation characteristics of the hardware used to implement the primary machine learning model 110. For example, the voltage and/or current used by the hardware (e.g., one or more processors and/or accelerators) may be monitored during one or more operations (e.g., one or more layers) of processing of the input 105, and this power dissipation information can be used as the label (e.g., target output) for the secondary machine learning model 130. That is, the secondary machine learning model 130 may learn to predict the power dissipation (e.g., voltage and current) for one or more operations of the primary machine learning model 110.

Further, although the illustrated example depicts the secondary machine learning model 130 using the distribution statistics 125A of the input 105 as input, in some aspects, the secondary machine learning model 130 may additionally or alternatively use other data, such as the distribution statistics of one or more intermediate tensors generated while processing the input 105 using the primary machine learning model 110. In some aspects, these actual distribution statistics 125B may be used as live feedback or input to the secondary machine learning model 130 during runtime. For example, the secondary machine learning model 130 may be used to generate a first prediction for the first layer of the primary machine learning model 110, and then the actual distribution statistics 125B of the first layer may be used as input to generate the prediction(s) for one or more subsequent layers of the primary machine learning model 110.

In these ways, the secondary machine learning model 130 may be efficiently trained to predict the distribution statistics and/or power dissipation of one or more operations of the primary machine learning model 110. This allows the power supply to the hardware components used to implement the primary machine learning model 110 (e.g., the physical components used to perform the operations) to be dynamically and adaptively adjusted, which can substantially improve the operations of the machine learning system (e.g. through reduced power dissipation caused by waste, such as due to excess power supply, and/or through improved performance and reliability caused by inadequate power supply).

### Example Workflow for Using Machine Learning Models to Improve Power Management

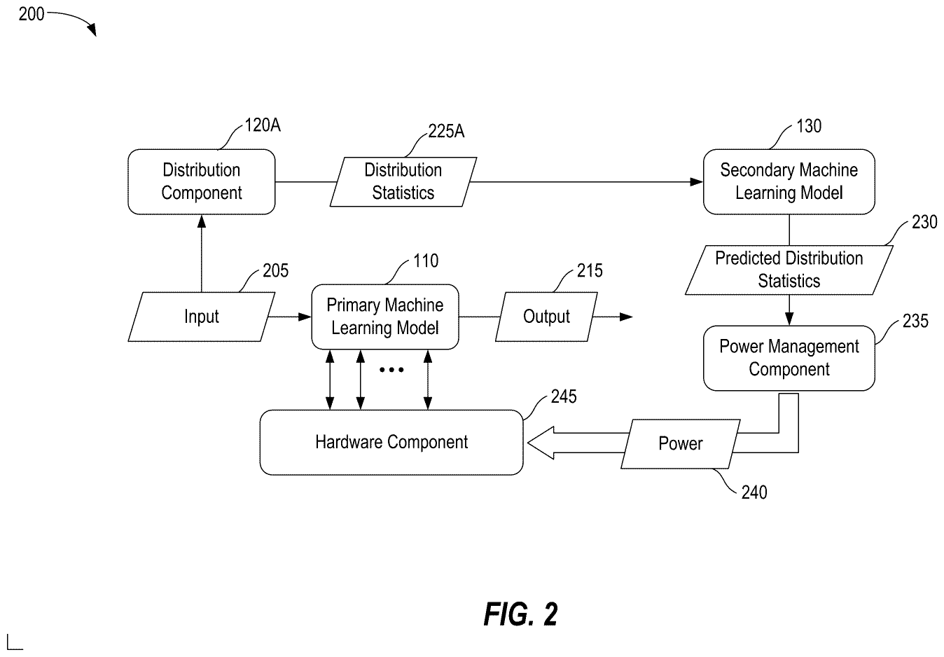

FIG. 2 depicts an example workflow 200 for using machine learning models to improve power management, according to some aspects of the present disclosure. In some aspects, the workflow 200 is performed by a machine learning system (e.g., a computing system configured to train and/or use machine learning models to process data). The machine learning system used to implement the workflow 200 may correspond to or be the same as the machine learning system used to train the secondary machine learning model 130 using the workflow 100 of FIG. 1, or may be a discrete system.

In the illustrated example, an input 205 is used as input to the primary machine learning model 110 to generate a corresponding output 215. As discussed above, the particular contents and format of the input 205 and the output 215 may vary depending on the particular implementation. For example, the input 205 may comprise image data (e.g., an RGB image) while the output 215 may comprise one or more predictions for the input image (e.g., a semantic segmentation, a depth map, and the like).

In the illustrated example, the primary machine learning model 110 is implemented using a hardware component 245. That is, the operations of the primary machine learning model 110 may be implemented or performed by the hardware component 245. The hardware component 245 generally corresponds to one or more physical hardware resources used to process the input 205 and perform the operations of the primary machine learning model 110. For example, depending on the particular implementation and architecture of the primary machine learning model 110, the hardware component 245 may comprise one or more processors (e.g., cores of a central processing unit (CPU), a graphics processing unit (GPU), a neural processing unit (NPU), and the like), a matrix engine, a single instruction multiple data (SIMD) component, and the like.

As illustrated, the input 205 is also accessed by the distribution component 120A to generate a set of distribution statistics 225A. In some aspects, the distribution statistics 225A correspond to the distribution statistics 125A of FIG. 1. For example, the distribution statistics 225A may include one or more statistics (e.g., the mean, mode, standard deviation, variance, maximum, minimum, first percentile, third percentile, skewness, kurtosis, and the like) of one or more distributions (e.g., a distribution of pixel values) of the input 205. In some aspects, if the input 205 has multiple channels (e.g., a first channel for red image data, a second channel for green image data, and a third channel for blue image data), the distribution statistics 225A may similarly include a respective set of distribution statistics for each respective channel, as discussed above.

Although not depicted in the illustrated example, in some aspects, the secondary machine learning model 130 may additionally or alternatively use distribution statistics for the parameters of the primary machine learning model 110 as input, as discussed above.

In the illustrated workflow 200, based on the distribution statistics 225A, the secondary machine learning model 130 generates a set of predicted distribution statistics 230. As discussed above, the predicted distribution statistics 230 may generally comprise predicted statistics (e.g., mean, standard deviation, and the like) of one or more operations of the primary machine learning model 110 (e.g., the distribution statistics of one or more intermediate tensors generated by the one or more operations). In some aspects, the predicted distribution statistics 230 are generated prior to the primary machine learning model 110 beginning processing of the input 205 (e.g., before the first operation, such as the first layer, is executed).

As illustrated, the predicted distribution statistics 230 are accessed by a power management component 235, which evaluates the predicted distribution statistics 230 to control the supply of power 240 to the hardware component 245. That is, based on the predicted distribution statistics 230, the power management component 235 may predict the power dissipation of the hardware component 245 during (e.g., while executing) one or more operations of the primary machine learning model 110. In some aspects, predicting the power dissipation of a given operation comprises predicting whether the power dissipation of the given operation will be higher or lower than the power dissipation of one or more prior operations (e.g., the immediately prior operation).

For example, the power management component 235 may predict that power dissipation will increase if the predicted distribution statistics 230 of the given operation indicate more complexity (e.g., less sparsity) than the predicted distribution statistics 230 of the immediately prior operation. This prediction of increased, decreased, or similar power dissipation may allow the power management component 235 to adaptively scale the power 240 (e.g., the voltage and/or current) up and down as the operations are performed.

In some aspects, the power management component 235 may control the power 240 with an effort to overshoot the actual power dissipation by a defined amount or percentage (e.g., a relatively small amount), so as to ensure sufficient power 240 is available to perform the operation without wasting excess power.

Generally, the power management component 235 may correspond to or comprise a variety of components that provide power to the hardware component 245, depending on the particular implementation. For example in some aspects, the power management component 235 may comprise one or more power management integrated circuits (PMICs), one or more switched-mode power supplies, and the like.

Although the illustrated example depicts the secondary machine learning model 130 generating predicted distribution statistics 230, in some aspects, the secondary machine learning model 130 may instead directly predict the power dissipation (e.g., voltage and/or current) of the one or more operations, as discussed above. That is, rather than predicting distribution statistics of the tensors and allowing the power management component 235 to predict the power dissipation (or changes in power dissipation), the secondary machine learning model 130 may itself predict the power dissipation (or the changes in power dissipation, as discussed above). This predicted power dissipation information can then be used to control the supply of the power 240 to the hardware component, as discussed above.

In these ways, using the workflow 200, the machine learning system can dynamically predict the power dissipation of one or more operations of the machine learning model, allowing the power supply to the hardware component 245 to be adaptively controlled (e.g., increased and/or decreased) based on the dissipation. This can substantially reduce the wasted power consumption and/or dissipation, which not only preserves battery life (which is particularly useful in the case of battery-operated devices, but is also valuable in devices that consume mains power) but also reduces heat generation (which, in turn, can mitigate or eliminate degradation of the hardware components of the machine learning system itself).

### Example Method for Controlling Power for Machine Learning Model Usage

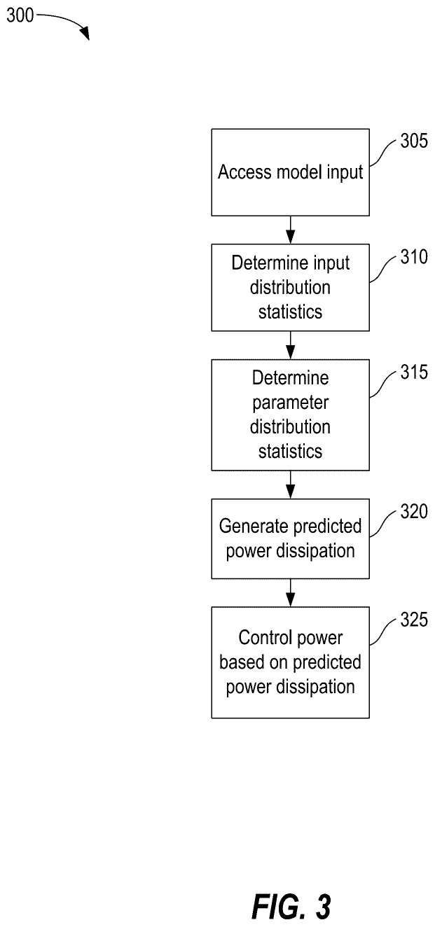

FIG. 3 is a flow diagram depicting an example method 300 for controlling power for machine learning model usage, according to some aspects of the present disclosure. In some aspects, the method 300 is performed by a machine learning system (e.g., a computing system configured to train and/or use machine learning models to process data). The machine learning system used to implement the method 300 may correspond to or be the same as one or more of the machine learning system(s) discussed above with reference to FIGS. 1-2, or may be a discrete system.

At block 305, the machine learning system accesses model input (e.g., the input 205 of FIG. 2). As discussed above, the particular contents and format of the input may vary depending on the particular implementation. For example, the model input may comprise image data (e.g., an RGB image) having a height and width (e.g., spatial dimensions) defined in number of pixels, and a depth of one or more channels.

At block 310, the machine learning system determines a set of input distribution statistics (e.g., the distribution statistics 225A of FIG. 2) based on the model input. In some aspects, the machine learning system may generate a respective set of distribution statistics for each respective channel in the model input. As discussed above, the particular statistics used may vary depending on the particular implementation, and may include features such as the mean pixel value in each channel, the standard deviation of the pixel values in each channel, the minimum and/or maximum pixel value in each channel, the first and/or third percentile pixel value in each channel, the skewness and/or kurtosis of the pixel values of each channel, and the like.

At block 315, the machine learning system optionally determines a set of parameter distribution statistics based on the parameters (e.g., weights and/or biases) of one or more operations (e.g., layers) of the machine learning model that will be used to process the model input (e.g., the primary machine learning model 110 of FIG. 2). In some aspects, as discussed above, these parameter distribution statistics may be particularly valuable for larger models (but may be less impactful for shallower primary models).

At block 320, the machine learning system generates, based on processing the input distribution statistics and/or the parameter distribution statistics using a second machine learning model (e.g., the secondary machine learning model 130 of FIG. 2), a predicted power dissipation of one or more hardware components (e.g., the hardware component 245 of FIG. 2) that will be used to implement the machine learning model.

In some aspects, as discussed above, predicting the power dissipation can include using the secondary machine learning model to predict the intermediate distribution statistics of one or more intermediate tensors generated by the model (e.g., the tensors that will be used as input to each operation), and predicting the power dissipation based on these predicted tensor statistics (e.g., predicting whether power dissipation will increase, decrease, or remain relatively constant for each operation). As another example, in some aspects, predicting the power dissipation may include using the secondary machine learning model to directly predict the power dissipation (e.g., the voltage and/or current) of each operation.

At block 325, the machine learning system controls the supply of power (e.g. the power 240 of FIG. 2) to the hardware component(s) based on the predicted power dissipation. For example, as discussed above, while the hardware component implements the primary machine learning model to process the model input, the machine learning system may vary the supplied power during each operation based on the predicted dissipation. As discussed above, this may reduce power consumption and heat generation of the machine learning system.

### Example Method for Controlling Compute Operations Based on Predicted Statistics

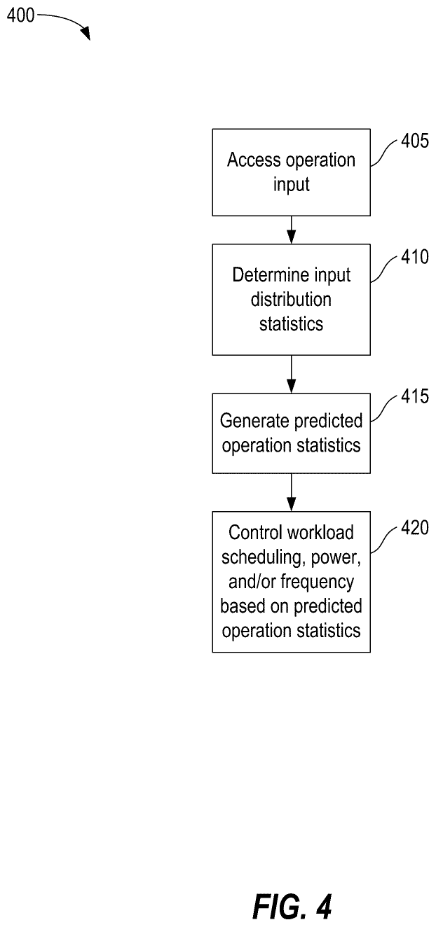

FIG. 4 is a flow diagram depicting an example method 400 for controlling compute operations based on predicted statistics, according to some aspects of the present disclosure. In some aspects, the method 400 is performed by a computing system (e.g., a machine learning system). The computing system used to implement the method 400 may correspond to or be the same as one or more of the machine learning system(s) discussed above with reference to FIGS. 1-3, or may be a discrete system.

In some aspects, as discussed above, the techniques described herein can be used to predict the sequential distributions and/or statistics related to processing data using a machine learning model (e.g., a deep neural network or LLM). In some aspects, these techniques can be also used in other settings where sequential processing is performed, such as in various digital signal processors (DSPs) and/or application-specific integrated circuits (ASICs). For example, using the techniques described herein, processor core scheduling and/or dynamic voltage and frequency scaling (DVFS) can be optimized (or at least improved) to reduce overall latency and/or power consumption.

For example, consider a multithreading environment where a cluster of four CPU cores are in streaming mode, sharing a common scalable matrix extension (SME) matrix engine for matrix operations. In some aspects, using the techniques described above for prediction of sequential distribution statistics can lead to improved DVFS for the cores and/or the SME engine.

At block 405, the computing system accesses input data that will be used as input for one or more operations of the machine learning system. For example, as discussed above, the input may include input for a machine learning model, or input to one or more other operations of the system (e.g., the first operation of a sequence of operations that will be performed).

At block 410, the computing system determines or generates a set of input distribution statistics based on the accessed input. For example, as discussed above, the computing system may determine statistics such as the mean, standard deviation, skewness, kurtosis, and the like.

At block 415, the computing system generates a set of predicted operation statistics based on processing the input distribution statistics using a machine learning model (e.g., the secondary machine learning model 130 of FIGS. 1-2). For example, as discussed above, the predicted operation statistics may include the predicted mean, standard deviation, and the like for one or more pieces of intermediate data that will be generated by one or more operations of the sequence of operations (which will be used to process the input).

At block 420, the computing system can use the predicted operation statistics to control various features such as workload scheduling (e.g., the scheduling of workloads on one or more processor cores and/or on the matrix engine), duty cycle of the hardware components, power supply (e.g., voltage and/or current) of the power supplied to one or more hardware components used to implement the operations, frequency (e.g., adjusting the clock speed), and the like. For example, as discussed above, the computing system may dynamically adjust these and other features based on the predicted statistics to improve the efficiency of the computing system and reduce power consumption and heat generation.

### Example Method for Supplying Power

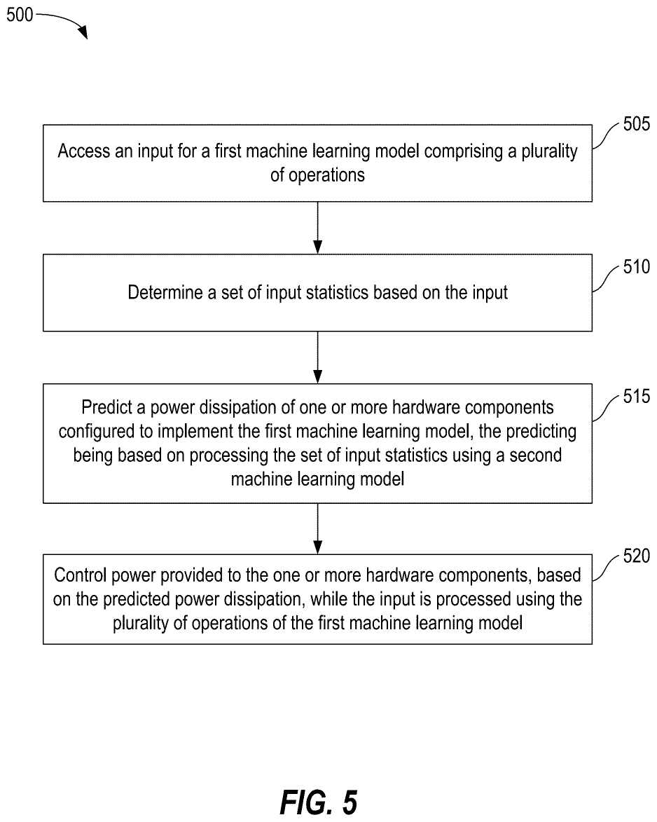

FIG. 5 is a flow diagram depicting an example method 500 for supplying power, according to some aspects of the present disclosure. In some aspects, the method 500 is performed by a machine learning system (e.g., a computing system configured to train and/or use machine learning models to process data). The machine learning system used to implement the method 400 may correspond to or be the same as one or more of the machine learning system(s) discussed above with reference to FIGS. 1-4, or may be a discrete system.

At block 505, an input (e.g., the input 205 of FIG. 2) for a first machine learning model (e.g., the primary machine learning model 110 of FIGS. 1-2) comprising a plurality of operations is accessed.

At block 510, a set of input statistics (e.g., the distribution statistics 225A of FIG. 2) is determined based on the input.

At block 515, a power dissipation of one or more hardware components configured to implement the first machine learning model (e.g., the hardware component 245 of FIG. 2) is predicted, the predicting being based on processing the set of input statistics using a second machine learning model (e.g., the secondary machine learning model 130 of FIGS. 1-2).

At block 520, power provided to the one or more hardware components (e.g., the power 240 of FIG. 2) is controlled, based on the predicted power dissipation, while the input is processed using the plurality of operations of the first machine learning model.

In some aspects, the set of input statistics comprises a mean of the input and a standard deviation of the input.

In some aspects, the set of input statistics comprises, for each respective channel of a plurality of channels of the input, a respective mean and a respective standard deviation.

In some aspects, the set of input statistics further comprises at least one of (i) a skewness of the input, (ii) a kurtosis of the input, (iii) a mode of the input, (iv) a median of the input, (v) a range of the input, (vi) a minimum of the input, (vii) a maximum of the input, or (viii) a quantile of the input.

In some aspects, predicting the power dissipation comprises generating a set of predicted distribution statistics (e.g., the predicted distribution statistics 230 of FIG. 2) for a first operation of the plurality of operations as output of the second machine learning model based on processing the set of input statistics using the second machine learning model.

In some aspects, the method 500 further includes predicting, based on the set of predicted distribution statistics, whether power dissipation of the first operation will be higher or lower than power dissipation of a prior operation of the plurality of operations.

In some aspects, predicting the power dissipation comprises generating a predicted power dissipation of a first operation of the plurality of operations as output of the second machine learning model based on processing the set of input statistics using the second machine learning model.

In some aspects, predicting the power dissipation comprises processing a set of parameter distribution statistics corresponding to parameters of the first machine learning model using the second machine learning model.

In some aspects, controlling the power comprises controlling at least one of (i) one or more power management integrated circuits, or (ii) one or more switched-mode power supplies, (e.g., the power management component 235 of FIG. 2) providing the power to the one or more hardware components.

### Example Processing System for Controlling Power

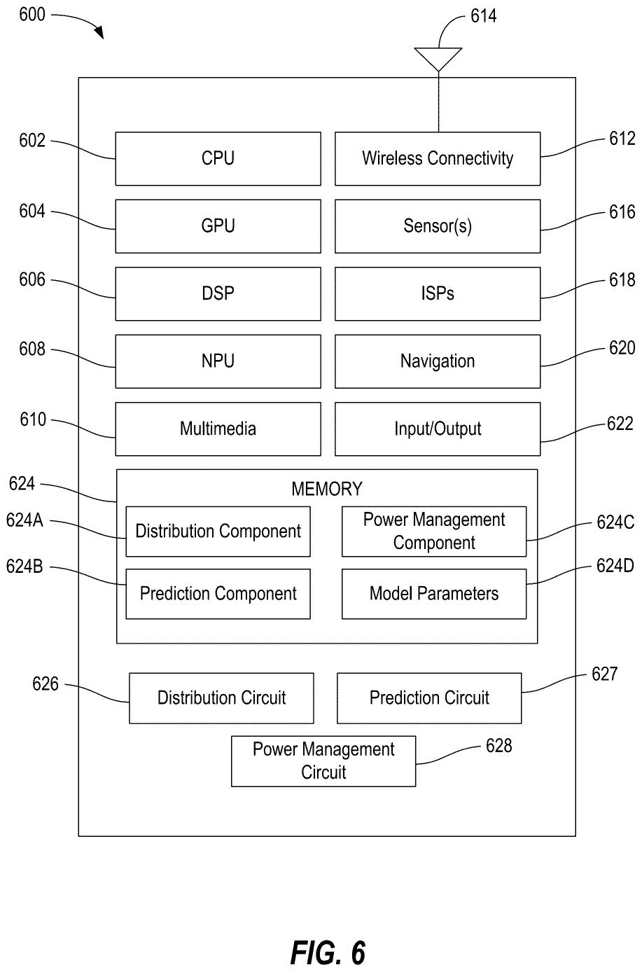

FIG. 6 depicts an example processing system 600 configured to perform various aspects of the present disclosure, including, for example, the techniques and methods described with respect to FIGS. 1-5. In some aspects, the processing system 600 may correspond to a machine learning system, such as one or more of the machine learning system(s) discussed above with reference to FIGS. 1-5. Although depicted as a single system for conceptual clarity, in some aspects, as discussed above, the components described below with respect to the processing system 600 may be distributed across any number of devices or systems.

The processing system 600 includes a central processing unit (CPU) 602, which in some examples may be a multi-core CPU. Instructions executed at the CPU 602 may be loaded, for example, from a program memory associated with the CPU 602 or may be loaded from a memory partition (e.g., a partition of a memory 624).

The processing system 600 also includes additional processing components tailored to specific functions, such as a graphics processing unit (GPU) 604, a digital signal processor (DSP) 606, a neural processing unit (NPU) 608, a multimedia component 610 (e.g., a multimedia processing unit), and a wireless connectivity component 612.

An NPU, such as the NPU 608, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 608 is a part of one or more of the CPU 602, the GPU 604, and/or the DSP 606.

In some examples, the wireless connectivity component 612 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 612 is further coupled to one or more antennas 614.

The processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS) as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of the processing system 600 may be based on an ARM or RISC-V instruction set.

The processing system 600 also includes a memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

In particular, in this example, the memory 624 includes a distribution component 624A, a prediction component 624B, and a power management component 624C. Although not depicted in the illustrated example, the memory 624 may also include other components, such as a training component to train the machine learning model(s) and/or an inferencing component to generate output of the primary model(s). Though depicted as discrete components for conceptual clarity in FIG. 6, the illustrated components (and others not depicted) may be collectively or individually implemented in various aspects.

Further, as illustrated, the memory 624 may also include various data, such as a set of model parameters 624D (e.g., parameters of one or more machine learning models, such as the primary machine learning model 110 and/or the secondary machine learning model 130, each of FIGS. 1-2), training and/or calibration data, and the like.

The processing system 600 further comprises a distribution circuit 626, a prediction circuit 627, and a power management circuit 628. The depicted circuits, and others not depicted (such as an inferencing or training circuit), may be configured to perform various aspects of the techniques described herein.

The distribution component 624A and/or the distribution circuit 626 (which may correspond to the distribution component 120A and/or 120B of FIGS. 1-2) may be used to determine or generate distribution statistics (e.g., the distribution statistics 125A and/or 125B of FIG. 1, and/or the distribution statistics 225A of FIG. 2) for various tensors and operations, as discussed above. For example, the distribution component 624A and/or the distribution circuit 626 may generate input distribution statistics based on the input to a machine learning model or other sequence of operations (e.g., the input 105 of FIG. 1 and/or the input 205 of FIG. 2), as well as based on the intermediate data generated by the operations for training purposes.

The prediction component 624B and/or the prediction circuit 627 (which may correspond to the primary machine learning model 110 and/or the secondary machine learning model 130, each of FIGS. 1-2) may be used to generate output predictions from one or more machine learning models, as discussed above. For example, in the case of the primary machine learning model, the prediction component 624B and/or the prediction circuit 627 may manage implementation of the model to process the input in order to generate model output (e.g., the output 115 of FIG. 1 and/or the output 215 of FIG. 2). In the case of the secondary machine learning model, the prediction component 624B and/or the prediction circuit 627 may manage implementation of the model to process the inputs in order to generate corresponding output (e.g., the predicted distribution statistics 230 of FIG. 2 and/or predicted power dissipation, as discussed above).

The power management component 624C and/or the power management circuit 628 (which may correspond to the power management component 235 of FIG. 2 and/or may be implemented as a PMIC) may be used to manage or control power supply to one or more hardware components (e.g., the hardware component 245 of FIG. 2), as discussed above. For example, the power management component 624C and/or the power management circuit 628 may evaluate the predicted distribution statistics for one or more internal operations in the primary model to dynamically control the power supply.

Though depicted as separate components and circuits for clarity in FIG. 6, the distribution circuit 626, the prediction circuit 627, and the power management circuit 628 may collectively or individually be implemented in other processing devices of the processing system 600, such as within the CPU 602, the GPU 604, the DSP 606, the NPU 608, and the like.

Generally, the processing system 600 and/or components thereof may be configured to perform the methods described herein.

Notably, in other aspects, elements of the processing system 600 may be omitted, such as where the processing system 600 is a server computer or the like. For example, the multimedia component 610, the wireless connectivity component 612, the sensor processing units 616, the ISPs 618, and/or the navigation processor 620 may be omitted in other aspects. Further, elements of the processing system 600 may be distributed between multiple devices.

### Example Clauses

Implementation examples are described in the following numbered clauses:
Clause 1: A method, comprising: accessing an input for a first machine learning model comprising a plurality of operations; determining a set of input statistics based on the input; predicting a power dissipation of one or more hardware components configured to implement the first machine learning model, the predicting being based on processing the set of input statistics using a second machine learning model; and controlling power provided to the one or more hardware components, based on the predicted power dissipation, while the input is processed using the plurality of operations of the first machine learning model.
Clause 2: A method according to Clause 1, wherein the set of input statistics comprises a mean of the input and a standard deviation of the input.
Clause 3: A method according to Clause 2, wherein the set of input statistics comprises, for each respective channel of a plurality of channels of the input, a respective mean and a respective standard deviation.
Clause 4: A method according to any of Clauses 2-3, wherein the set of input statistics further comprises at least one of (i) a skewness of the input, (ii) a kurtosis of the input, (iii) a mode of the input, (iv) a median of the input, (v) a range of the input, (vi) a minimum of the input, (vii) a maximum of the input, or (viii) a quantile of the input.
Clause 5: A method according to any of Clause 1-4, wherein predicting the power dissipation comprises generating a set of predicted distribution statistics for a first operation of the plurality of operations as output of the second machine learning model based on processing the set of input statistics using the second machine learning model.
Clause 6: A method according to Clause 5, further comprising predicting, based on the set of predicted distribution statistics, whether power dissipation of the first operation will be higher or lower than power dissipation of a prior operation of the plurality of operations.
Clause 7: A method according to any of Clauses 1-6, wherein predicting the power dissipation comprises generating a predicted power dissipation of a first operation of the plurality of operations as output of the second machine learning model based on processing the set of input statistics using the second machine learning model.
Clause 8: A method according to any of Clauses 1-7, wherein predicting the power dissipation comprises processing a set of parameter distribution statistics corresponding to parameters of the first machine learning model using the second machine learning model.
Clause 9: A method according to any of Clauses 1-8, wherein controlling the power comprises controlling at least one of (i) one or more power management integrated circuits, or (ii) one or more switched-mode power supplies, providing the power to the one or more hardware components.
Clause 10: A method, comprising: accessing an input for a sequence of operations; determining a set of input statistics based on the input; predicting one or more statistics of the sequence of operations when executed using one or more hardware components, the predicting being based on processing the set of input statistics using a machine learning model; and controlling at least one of (i) workload scheduling, (ii) power provided to the one or more hardware components, or (iii) frequency of the one or more hardware components, based on the one or more predicted statistics, while the input is processed using the sequence of operations.
Clause 11: A processing system comprising: one or more memories comprising processor-executable instructions; and one or more processors coupled to the one or more memories and configured to execute the processor-executable instructions and cause the processing system to perform a method in accordance with any of Clauses 1-10.
Clause 12: A mobile device comprising the processing system of Clause 11.
Clause 13: A processing system comprising means for performing a method in accordance with any of Clauses 1-10.
Clause 14: A non-transitory computer-readable medium comprising computer-executable instructions that, when executed by one or more processors of a processing system, cause the processing system to perform a method in accordance with any of Clauses 1-10.
Clause 15: A computer program product embodied on a computer-readable storage medium comprising code for performing a method in accordance with any of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system, comprising:
one or more memories comprising processor-executable instructions; and
one or more processors coupled to the one or more memories and configured to execute the processor-executable instructions and cause the processing system to:
access an input for a first machine learning model comprising a plurality of operations;
determine a set of input statistics based on the input;
predict a power dissipation of one or more hardware components configured to implement the first machine learning model, the power dissipation being predicted based on processing the set of input statistics using a second machine learning model; and
control power provided to the one or more hardware components, based on the predicted power dissipation, while the input is processed using the plurality of operations of the first machine learning model.

2. The processing system of claim 1, wherein the set of input statistics comprises a mean of the input and a standard deviation of the input.

3. The processing system of claim 2, wherein the set of input statistics comprises, for each respective channel of a plurality of channels of the input, a respective mean and a respective standard deviation.

4. The processing system of claim 2, wherein the set of input statistics further comprises at least one of (i) a skewness of the input, (ii) a kurtosis of the input, (iii) a mode of the input, (iv) a median of the input, (v) a range of the input, (vi) a minimum of the input, (vii) a maximum of the input, or (viii) a quantile of the input.

5. The processing system of claim 1, wherein, to predict the power dissipation, the one or more processors are configured to execute the processor-executable instructions and cause the processing system to generate a set of predicted distribution statistics for a first operation of the plurality of operations as output of the second machine learning model based on processing the set of input statistics using the second machine learning model.

6. The processing system of claim 5, wherein the one or more processors are configured to execute the processor-executable instructions and further cause the processing system to predict, based on the set of predicted distribution statistics, whether power dissipation of the first operation will be higher or lower than power dissipation of a prior operation of the plurality of operations.

7. The processing system of claim 1, wherein, to predict the power dissipation, the one or more processors are configured to execute the processor-executable instructions and cause the processing system to generate a predicted power dissipation of a first operation of the plurality of operations as output of the second machine learning model based on processing the set of input statistics using the second machine learning model.

8. The processing system of claim 1, wherein, to predict the power dissipation, the one or more processors are configured to execute the processor-executable instructions and cause the processing system to process a set of parameter distribution statistics corresponding to parameters of the first machine learning model using the second machine learning model.

9. The processing system of claim 1, wherein, to control the power, the one or more processors are configured to execute the processor-executable instructions and cause the processing system to control at least one of (i) one or more power management integrated circuits, or (ii) one or more switched-mode power supplies, providing the power to the one or more hardware components.

10. A mobile device comprising the processing system of claim 1.

11. A processor-implemented method of supplying power, comprising:
accessing an input for a first machine learning model comprising a plurality of operations;
determining a set of input statistics based on the input;
predicting a power dissipation of one or more hardware components configured to implement the first machine learning model, the predicting being based on processing the set of input statistics using a second machine learning model; and
controlling power provided to the one or more hardware components, based on the predicted power dissipation, while the input is processed using the plurality of operations of the first machine learning model.

12. The processor-implemented method of claim 11, wherein the set of input statistics comprises a mean of the input and a standard deviation of the input.

13. The processor-implemented method of claim 12, wherein the set of input statistics comprises, for each respective channel of a plurality of channels of the input, a respective mean and a respective standard deviation.

14. The processor-implemented method of claim 12, wherein the set of input statistics further comprises at least one of (i) a skewness of the input, (ii) a kurtosis of the input, (iii) a mode of the input, (iv) a median of the input, (v) a range of the input, (vi) a minimum of the input, (vii) a maximum of the input, or (viii) a quantile of the input.

15. The processor-implemented method of claim 11, wherein predicting the power dissipation comprises generating a set of predicted distribution statistics for a first operation of the plurality of operations as output of the second machine learning model based on processing the set of input statistics using the second machine learning model.

16. The processor-implemented method of claim 15, further comprising predicting, based on the set of predicted distribution statistics, whether power dissipation of the first operation will be higher or lower than power dissipation of a prior operation of the plurality of operations.

17. The processor-implemented method of claim 11, wherein predicting the power dissipation comprises generating a predicted power dissipation of a first operation of the plurality of operations as output of the second machine learning model based on processing the set of input statistics using the second machine learning model.

18. The processor-implemented method of claim 11, wherein predicting the power dissipation comprises processing a set of parameter distribution statistics corresponding to parameters of the first machine learning model using the second machine learning model.

19. The processor-implemented method of claim 11, wherein controlling the power comprises controlling at least one of (i) one or more power management integrated circuits, or (ii) one or more switched-mode power supplies, providing the power to the one or more hardware components.

20. A processor-implemented method of controlling operation implementation, comprising:
accessing an input for a sequence of operations;
determining a set of input statistics based on the input;
predicting one or more statistics of the sequence of operations when executed using one or more hardware components, the predicting being based on processing the set of input statistics using a machine learning model; and
controlling at least one of (i) workload scheduling, (ii) power provided to the one or more hardware components, or (iii) frequency of the one or more hardware components, based on the one or more predicted statistics, while the input is processed using the sequence of operations.
